(19) United States
(12) Patent Application Publication
(10) Pub. No.: US 2015/0002952 A1
(43) Pub. Date: Jan. 1, 2015

(54) MIRROR ASSEMBLY

(71) Applicant: GM GLOBAL TECHNOLOGY OPERATIONS LLC, Detroit, MI (US)

(72) Inventor: Brian V. Castillo, Birmingham, MI (US)

(21) Appl. No.: 13/929,894

(22) Filed: Jun. 28, 2013

(51) Int. Cl. B60R 1/08

(52) U.S. Cl. CPC B60R 1/081
USPC 359/841

(57) ABSTRACT

A mirror assembly for a vehicle includes a housing, a first mirror, and a second mirror. The housing includes a plurality of sides and is configured to rotate about a first axis. The plurality of sides includes a first side and a second side. The first side has a first length extending in perpendicular relationship to the first axis. The second side has a second length extending in perpendicular relationship to the first axis. The first side is adjacent the second side such that a first angle is defined therebetween. The first length is greater than the second length. The first mirror is operatively attached to the first side and the second mirror is operatively attached to the second side. The first mirror presents a greater surface area than the second mirror.

### TECHNICAL FIELD

This disclosure relates to mirror assemblies for vehicles.

### BACKGROUND

Vehicles may include one or more mirrors to expand the area viewable to drivers or operators. Generally, rear view mirrors help the driver see behind the vehicle and side view mirrors help the driver see behind and to the side, or to both sides, of the vehicle.

### SUMMARY

A mirror assembly for a vehicle includes a housing, a first mirror, and a second mirror. The housing includes a plurality of sides and is configured to rotate about a first axis. The plurality of sides includes a first side and a second side. The first side has a first length extending in perpendicular relationship to the first axis. The second side has a second length extending in perpendicular relationship to the first axis. The first side is adjacent the second side such that a first angle is defined therebetween. The first length is greater than the second length. The first mirror is operatively attached to the first side and the second mirror is operatively attached to the second side. The first mirror presents a greater surface area than the second mirror.

In another aspect, a vehicle includes a panel and a mirror assembly. The mirror assembly includes a plurality of sides. The housing is operatively attached to the panel and configured to rotate about an axis, relative to the panel. The plurality of sides includes a first side and a second side. The first side has a first length extending in perpendicular relationship to the first axis. The second side has a second length extending in perpendicular relationship to the first axis. The first side is adjacent the second side such that a first angle is defined therebetween. The first length is greater than the second length. The first mirror is operatively attached to the first side and the second mirror is operatively attached to the second side. The first mirror presents a greater surface area than the second mirror.

The above features and advantages, and other features and advantages, of the present invention are readily apparent from the following detailed description of some of the best modes and other embodiments for carrying out the invention, which is defined solely by the appended claims, when taken in connection with the accompanying drawings.

### BRIEF DESCRIPTION OF THE DRAWINGS

FIG. 1 is a schematic rear perspective view of a mirror assembly attached to a panel of a vehicle, with the mirror assembly in a first position;

FIG. 2 is schematic rear perspective view of the mirror assembly of FIG. 1 attached to the panel of the vehicle, with the mirror assembly in a second position;

FIG. 3 is a schematic side view of the vehicle with the mirror assembly attached to the panel on a left side of the vehicle, in the first position;

FIG. 4 is a schematic top view of the vehicle with a pair of mirror assemblies attached to the panel on the left side and a right side, with the mirror assemblies in the first position;

FIG. 5 is a schematic side view of the vehicle with the mirror assembly attached to the panel on the left side of the vehicle, in the second position;

FIG. 6 is a schematic top view of the vehicle with the pair of mirror assemblies attached to the panel on the left side and right side with the mirror assemblies in the second position;

FIG. 7 is a schematic rear perspective view of another embodiment of the mirror assembly attached to the panel of the vehicle, with the mirror assembly in the first position; and

FIG. 8 is schematic rear perspective view of the mirror assembly of FIG. 7 attached to the panel of the vehicle, with the mirror assembly in the second position.

### DETAILED DESCRIPTION

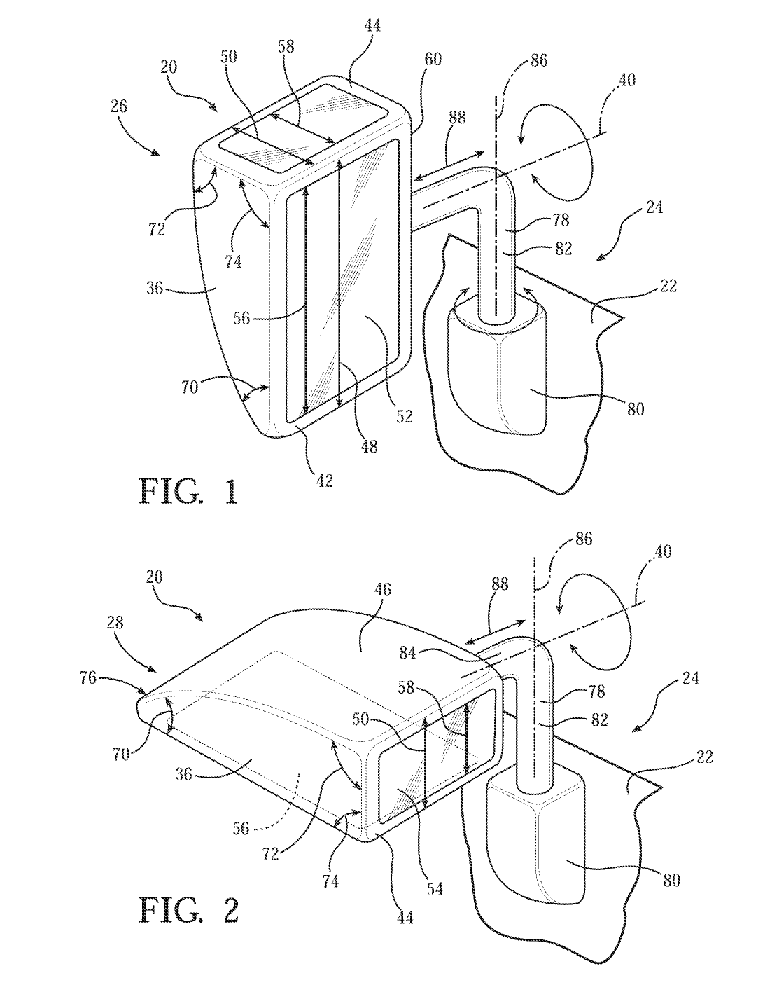

Referring to the drawings, like reference numbers correspond to like or similar components wherever possible throughout the several figures. FIGS. 1 and 2 show a schematic perspective view of a mirror assembly 20 attached to a panel 22 of a vehicle 24. The mirror assembly 20 illustrated in FIG. 1 is in a first position 26 and the mirror assembly 20 illustrated in FIG. 2 is in a second position 28, as will be explained in more detail below. Note that although the mirror assembly 20 is illustrated in FIGS. 1 and 2 as being attached to a left side 30 of the vehicle 24, reference to FIGS. 4 and 6 illustrate that the mirror assembly 20 may be attached to both a left side 30 and a right side 32 of the vehicle 24. Therefore, the structures and methods described herein apply equally to vehicles 24 with the mirror assembly 20 attached to the left side 30 and/or right side 32 of the vehicle 24.

It should be appreciated that the present disclosure should not be limited to use with only automotive or vehicular applications. Those having ordinary skill in the art will recognize that terms such as “forward”, “front”, “above,” “below,” “upward,” “downward,” et cetera, are used descriptively of the figures, and do not represent limitations on the scope of the invention, as defined by the appended claims. Any numerical designations, such as “first”, “second”, or “third” are illustrative only and are not intended to limit the scope of the invention in any way.

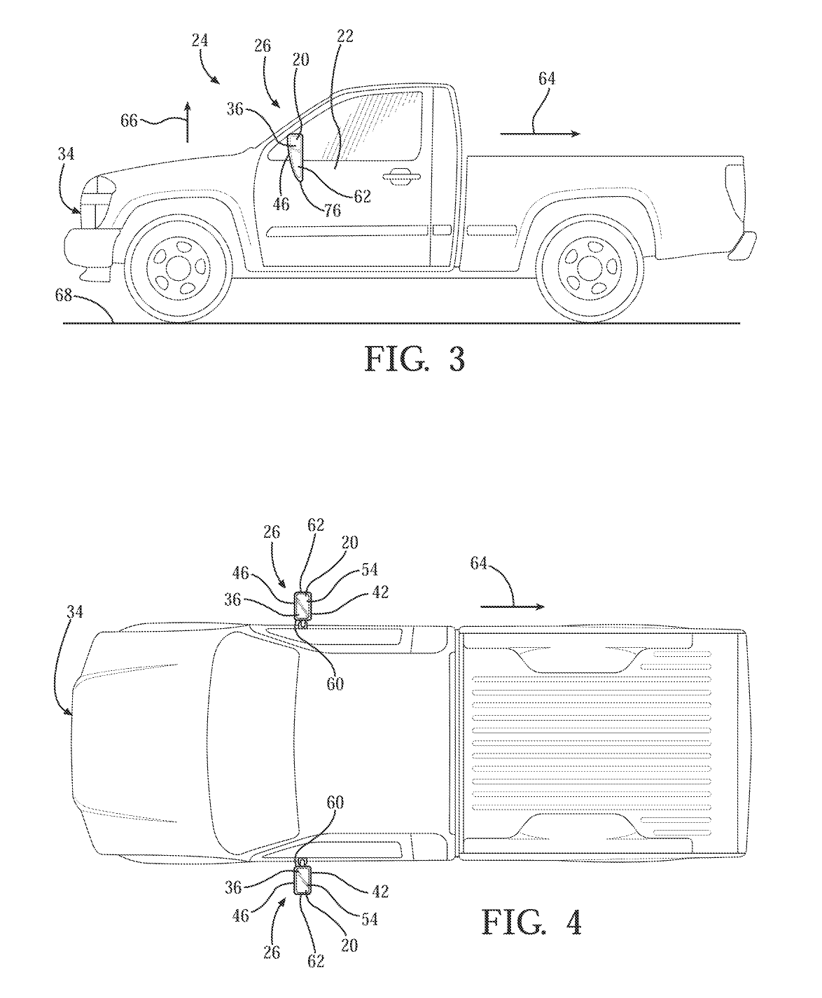

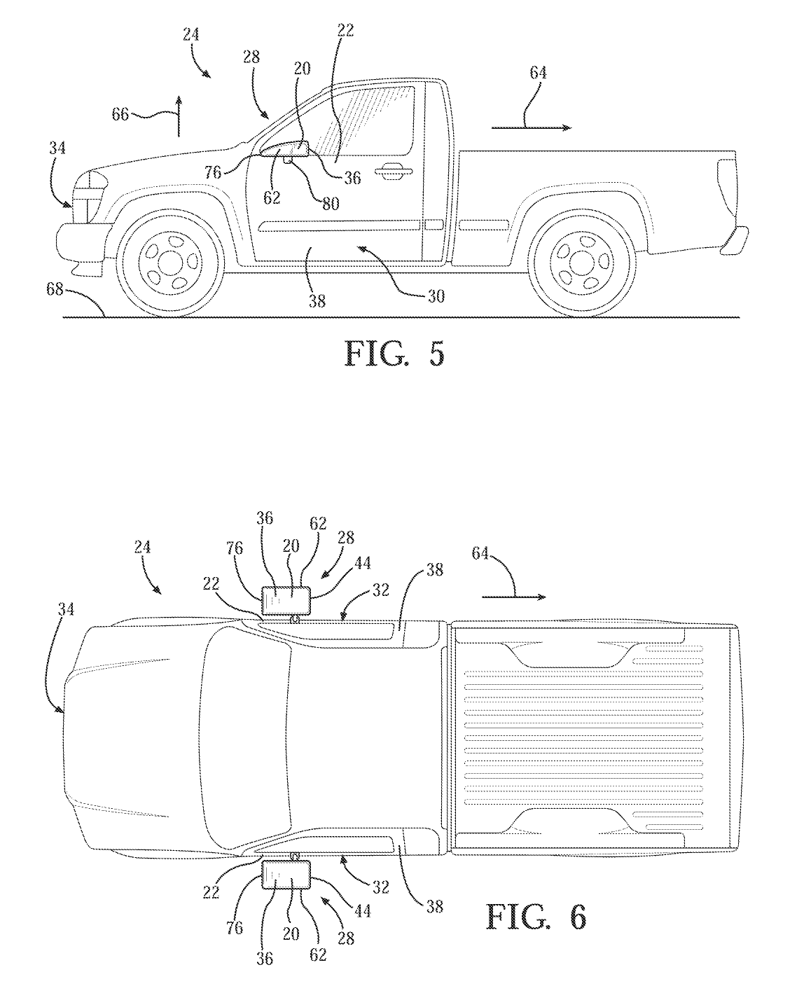

The mirror assembly 20 includes a housing 36 rotatably attached to the panel 22. The panel 22 may be a respective door 38, as illustrated in FIGS. 3-6, or may be a structure located forward of the door 38, relative to a front 34 of the vehicle 24. The housing 36 is configured to rotate relative to the panel 22, about a first axis 40, between the first position 26, as illustrated in FIGS. 1, 3, and 4, and the second position 28, as illustrated in FIGS. 2, 5, and 6. The first axis 40 may extend in generally perpendicular relationship to the panel 22.

The housing 36 includes a first side 42, a second side 44, and a third side 46. The first side 42 has a first length 48 extending in perpendicular relationship to the first axis 40. The second side 44 has a second length 50 extending in perpendicular relationship to the first axis 40 such that the first side 42 is adjacent the second side 44. The first length 48 is greater than the second length 50. The mirror assembly 20 also includes a first mirror 52 and a second mirror 54. The first mirror 52 and the second mirror 54 provide reflective surfaces configured to help an operator see behind and/or to a side 30, 32 of the vehicle. The first mirror 52 is operatively attached to the first side 42 and the second mirror 54 is operatively attached to the second side 44.

The first mirror 52 has a first height 56 and the second mirror 54 has a second height 58. The first height 56 is greater than the second height 58 such that the first mirror 52 presents a greater reflective surface area than the second mirror 54. The first height 56 of the first mirror 52 may be configured to not be greater than the first length 48 of the first side 42 and the second height 58 of the second mirror 54 may be configured to not be greater than the second length 50 of the second side 44. By way of a non-limiting example, the first height 56 of the first mirror 52 and the second height 58 of the second mirror 54 may be configured such that the first mirror 52 is recessed within the first side 42 and the second mirror 54 is recessed within the second side 44 of the housing 36. Therefore, the housing 36 may be configured to protect the first mirror 52 and the second mirror 54.

The first side 42 and the first mirror 52 may be configured such that the first mirror 52 conforms to the first side 42 when attached thereto. Likewise, the second side 44 and the second mirror 54 may be configured such that the second mirror 54 conforms to the second side 44 when attached thereto. In one non-limiting example, the first side 42, the second side 44, the first mirror 52, and the second mirror 54 may all be generally planar.

The third side 46 extends in perpendicular relationship to the first axis 40 such that the third side 46 is adjacent the first side 42 and the second side 44. As such, the first side 42, the second side 44, and the third side 46 form a generally triangular shape that surrounds the first axis 40. The third side 46 may be arcuately shaped to direct airflow around the mirror assembly 20 when the vehicle 24 is in motion.

When the mirror assembly 20 is in the first position 26, as illustrated in FIGS. 1, 3, and 4, the first mirror 52 faces a rearward direction 64, relative to the front 34 of the vehicle 24, and the second mirror 54 faces an upward direction 66, relative to the ground 68. The larger surface area provided by the first mirror 52 pane means that a larger reflection can be viewed by the operator when the mirror assembly 20 is in the first position 26. This may be useful when pulling trailers with the vehicle 24. Likewise, when the mirror assembly 20 is in the second position 28, as illustrated in FIGS. 2, 5, and 6, the second mirror 54 faces the rearward direction 64 and the first mirror 52 faces the ground 68.

A first angle 74 is defined between the first side 42 and the second side 44A, a second angle 72 is defined between the second side 44 and the third side 46, and a third angle 70 is defined between the first side 42 and the third side 46. The third angle 70 is less than the second angle 72 and the first angle 74 may be a right angle. As such, the triangular shape is a right triangle and the first side 42 extends in generally perpendicular relationship to the second side 44. The first side 42 and the second side 44 combine to present a first leading edge 76 therebetween. The first leading edge 76 is configured to face the front 34 of the vehicle 24 when the mirror assembly 20 is in the second position 28. Since the first leading edge 76 is associated with the third angle 70, the first leading edge 76 provides a small, low-drag configuration for regular driving. The low-drag configuration of the second position 28 provides an improved fuel economy and reduced wind noise over the first position 26. Likewise, when the mirror assembly 20 is in the first position 26, the first leading edge 76 is configured to face the ground 68 and the third side 46 is configured to face forward, thus presenting a second leading edge. When the second leading edge faces forward, the first mirror 52 is visible to the operator within the vehicle 24, thereby providing a larger reflective surface to the operator within the vehicle 24, with a less desirable aerodynamic configuration for use when towing a trailer.

The housing 36 includes a first face 60 and a second face 62. The first face 60 and the second face 62 are disposed in spaced and generally parallel relationship to one another such that the first side 42, second side 44, and third side 46 are disposed between the first face 60 and the second face 62. As such, the first side 42, second side 44, and third side 46 are disposed in perpendicular relationship to the first face 60 and the second face 62. The first face 60 and the second face 62 each interconnect the first side 42, second side 44, and third side 46 such that the first side 42, second side 44, and third side 46 are sandwiched between the first face 60 and the second face 62. The first face 60 is operatively connected to the panel 22 such that the first face 60 is disposed in the direction facing an interior of the vehicle 24 and the second face 62 is in the direction facing opposite the interior of the vehicle 24.

An arm 78 may operatively connect the housing 36 and the panel 22. As such, the housing 36 is configured to rotate about the first axis 40, relative to the arm 78 and the housing 36. The arm 78 creates an offset between the vehicle 24 and the housing 36. Additionally, it should be appreciated that the mirror assembly 20 is not limited to having only one arm 78, but may have more than one arm 78. The arm 78 may have a base portion 80 or base plate to support the housing 36. Therefore, the base portion 80 would be operatively connected to the panel 22 and the arm 78 would be operatively connected to the base portion 80. Referring to FIGS. 1 and 2, the arm 78 may have a first section 82 and a second section 84, where the first second extends from the base portion 80 in generally perpendicular relationship to the ground 68. The second section 84 extends generally perpendicularly from the first section 82 such that the first section 82 and the second section 84 form an L-shaped arm 78. The arm 78 may be formed from a tubular material and the like. The first side 42 of the mirror assembly 20 may be operatively attached to the second section 84 along the first axis 40. Therefore, the mirror assembly 20 is configured to rotate about the first axis 40, relative to the second section 84. Further, referring again to FIGS. 1 and 2, the mirror assembly 20 may be configured to slide along the first axis 40, relative to the second section 84, such that the mirror assembly 20 telescopes inboard and outboard relative to the panel 22, as indicated by the arrow 88.

Additionally, the arm 78 may be configured to rotate relative to the panel 22, about a second axis 86. The second axis 86 extends along the first section 82 such that the first axis 40 and the second axis 86 extend in generally perpendicular relationship to one another. The mirror assembly 20 rotates with the arm 78 about the second axis 86, relative to the panel 22. Rotation about the second axis 86 allows an angle of the mirror panes to vary relative to the respective panel 22 of the vehicle 24. It should be appreciated that the housing 36 may also include components that mechanically or electro-mechanically vary an angle of the mirror panes relative to an occupant located within the vehicle 24. This variation of the angle may be by rotating the mirror assembly 20 about the first axis 40, the second axis 86, or axially moving the mirror assembly 20 along the first axis 40, i.e., along arrow 88, relative to the panel 22. Alternatively, the variation of the angle may be manually moved by the operator of the vehicle 24.

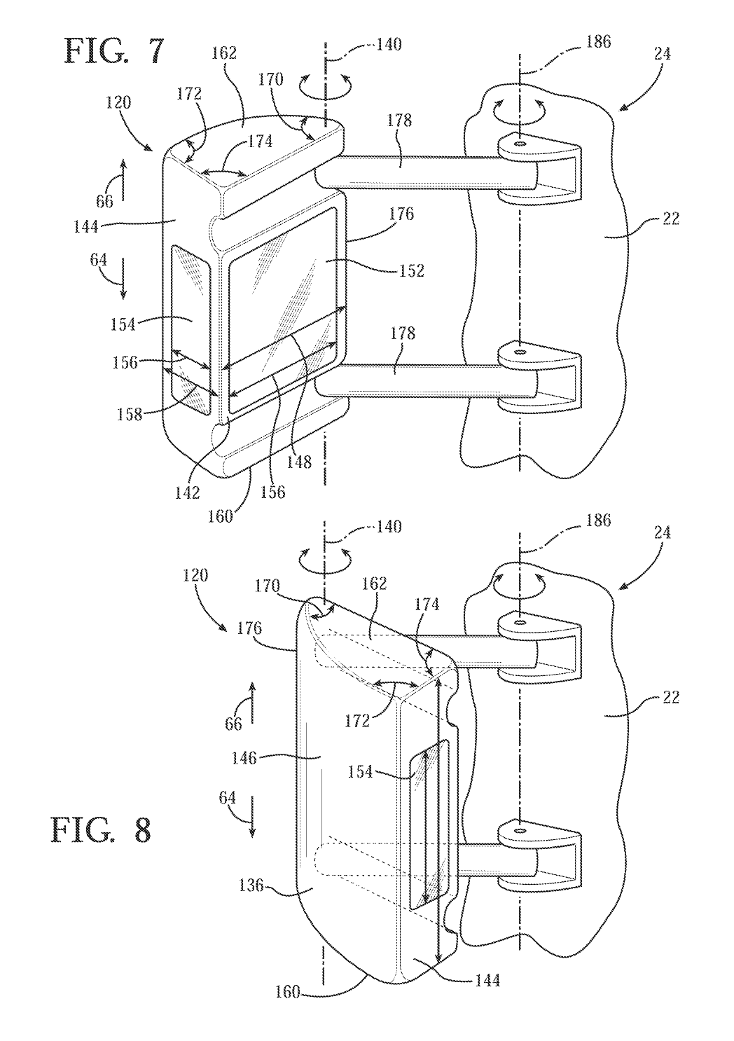

Referring to the embodiment shown in FIGS. 7 and 8, another mirror assembly 120 is shown. The mirror assembly 120 includes a housing 136 rotatably attached to the panel 22. The housing 136 is configured to rotate relative to the panel 22 about a first axis 140, between a first position 126, as shown in FIG. 7, and a second position 128, as shown in FIG. 8. The first axis 140 extends in generally parallel relationship to the panel 22.

The housing 136 is oriented relative to the panel 22 such that a first face 160 faces a downward direction 65 and the second face 162 is facing the upward direction 66. Referring to FIG. 7, when the mirror assembly 120 is in the first position 126, a third side 146 faces the front 34 of the vehicle 24, a first leading edge 176 faces the panel 22, a second side 144 faces opposite the panel 22, and a first side 142 faces the rearward direction 64, opposite the front 34 of the vehicle 24.

With continued reference to FIGS. 7 and 8, the first side 142 has a first length 148 that extends in generally perpendicular relationship to the first axis 140. The second side 144 has a second length 150 that extends in generally perpendicular relationship to the first axis 140 such that the first side 142 is adjacent the second side 144 such that the first angle 174 is defined therebetween. The first length 148 is greater than the second length 150. The mirror assembly 120 also includes a first mirror 152 and a second mirror 154. The first mirror 152 and the second mirror 154 provide reflective surfaces. The first mirror 152 is operatively attached to the first side 142 and the second mirror 154 is operatively attached to the second side 144.

The first mirror 152 has a first height 156 and the second mirror 154 has a second height 158. The first height 156 is greater than the second height 158 such that the first mirror 152 presents a greater surface area than the second mirror 154. The first height 156 of the first mirror 152 may be configured to not be greater than the first length 148 of the first side 142 and the second height 158 of the second mirror 154 may be configured to not be greater than the second length 150 of the second side 144. By way of a non-limiting example, the first height 156 of the first mirror 152 and the second height 158 of the second mirror 154 may be configured such that the first mirror 152 is recessed within the first side 142 and the second mirror 154 is recessed within the second side 144 of the housing 136. Therefore, the housing 136 may be configured to protect the first mirror 152 and the second mirror 154.

Since the first mirror 152 presents a larger surface area than the second mirror 154, when the mirror assembly 120 is in the first position 126 illustrated in FIG. 7, a larger reflective surface is presented to the operator for use when towing a trailer, while providing a less than preferable aerodynamic configuration.

However, when towing a trailer is not required, the mirror assembly 120 may be moved to the second position 128, as shown in FIG. 8. In the second position 128, the first leading edge 176 faces the front 34 of the vehicle 24, the first side 142 faces the panel 22, the third side 46 faces opposite the panel 22, and the third side 146 faces the rearward direction 64, opposite the front 34 of the vehicle 24. As such, when the mirror assembly 120 is in the second position 128, the second mirror 154 is visible to the operator of the vehicle 24. Since the second mirror 154 presents a smaller surface area than the first mirror 152, a smaller reflective surface is presented to the operator. Since the first leading edge 176 faces the front 34 of the vehicle 24 and the third side 46 faces opposite the panel 22, a low-drag configuration is provided, resulting in improved fuel economy and reduced wind noise over the first position 126.

The housing 36 may be operatively connected to the panel 22 with at least one arm 178. Referring to FIGS. 7 and 8, a pair of arms 78 linearly extend in spaced and parallel relationship to one another, between the panel 22 and the first leading edge 176 of the housing 136. The housing 136 is configured to rotate about the first axis 140, relative to the arms 178 to change the operator's view. Additionally, each of the arms 178 may be pivotally mounted to the panel 22 such that the arms 178 are configured to rotate relative to the panel 22 about a second axis 186. The first axis 140 and the second axis 186 may be disposed in spaced an parallel relationship to one another.

The detailed description and the drawings or figures are supportive and descriptive of the invention, but the scope of the invention is defined solely by the claims. While some of the best modes and other embodiments for carrying out the claimed invention have been described in detail, various alternative designs, configurations, and embodiments exist for practicing the invention defined in the appended claims.

1. A mirror assembly for a vehicle, comprising:
a housing including a plurality of sides, wherein the housing is configured to rotate about a first axis;
wherein the plurality of sides include a first side and a second side;
wherein the first side has a first length extending in perpendicular relationship to the first axis;
a first mirror operatively attached to the first side;
wherein the second side has a second length extending in perpendicular relationship to the first axis;
a second mirror operatively attached to the second side;
wherein the first length is greater than the second length;
wherein the first side is adjacent the second side such that a first angle is defined therebetween; and
wherein the first mirror presents a greater surface area than the second mirror.

2. A mirror assembly, as set forth in claim 1, wherein the mirror further includes a third side extending in perpendicular relationship to the first axis such that the third side extends between the first side and the second side.

3. A mirror assembly, as set forth in claim 2, wherein the first side, the second side, and the third side form a triangular shape that surrounds the first axis.

4. A mirror assembly, as set forth in claim 3, wherein a second angle is defined between the second side and the third side and a third angle is defined between the first side and the third side;
wherein the third angle is less than the second angle.

5. A mirror assembly, as set forth in claim 4, wherein the first angle is a right angle such that the triangular shape is a right triangle and the first side extends in generally perpendicular relationship to the second side.

6. A mirror assembly, as set forth in claim 4, wherein the first side and the second side are planar; and
wherein the third side is arcuately-shaped in the direction surrounding the first axis.

7. A mirror assembly, as set forth in claim 1, wherein the first mirror has a first height extending in perpendicular relationship to the first axis and the second mirror has a second height extending in perpendicular relationship to the first axis;
wherein the first height is greater than the second height.

8. A mirror assembly, as set forth in claim 7, wherein the first height is not greater than the first length and the second height is not greater than the second length.

9. A vehicle comprising:
a panel; and
a mirror assembly including:
a housing including a plurality of sides, wherein the housing is operatively attached to the panel and configured to rotate about a first axis, relative to the panel;
wherein the plurality of sides include a first side and a second side;
wherein the first side has a first length extending in perpendicular relationship to the first axis;
a first mirror operatively attached to the first side,
wherein the second side has a second length extending in perpendicular relationship to the first axis;
a second mirror operatively attached to the second side;
wherein the first side is adjacent the second side such that a first angle is defined therebetween;
wherein the first length is greater than the second length; and
wherein the first mirror presents a greater surface area than the second mirror.

10. A mirror assembly, as set forth in claim 9, wherein the mirror further includes a third side extending in perpendicular relationship to the first axis such that the third side extends between the first side and the second side.

11. A mirror assembly, as set forth in claim 10, wherein the first side, the second side, and the third side form a triangular shape that surrounds the first axis.

12. A mirror assembly, as set forth in claim 11, wherein a second angle is defined between the second side and the third side and a third angle is defined between the first side and the third side;
wherein the third angle is less than the second angle.

13. A mirror assembly, as set forth in claim 12, wherein the first angle is a right angle such that the triangular shape is a right triangle and the first side extends in generally perpendicular relationship to the second side such that the first side, the second side, and the third side surround the first axis.

14. A mirror assembly, as set forth in claim 12, wherein the first side and the second side are planar; and
wherein the third side is arcuately-shaped in the direction surrounding the first axis.

15. A mirror assembly, as set forth in claim 9, wherein the first mirror has a first height extending in perpendicular relationship to the first axis and the second mirror has a second height in perpendicular relationship to the first axis;
wherein the first height is greater than the second height.

16. A mirror assembly, as set forth in claim 15, wherein the first height is not greater than the first length and the second height is not greater than the second length.

17. A vehicle, as set forth in claim 9, further comprising an arm operatively connecting the housing and the panel such that the housing is configured to rotate about the first axis, relative to the arm.
